(19) United States
(12) Patent Application Publication
(10) Pub. No.: US 2020/0098494 A1
(43) Pub. Date: Mar. 26, 2020

(54) Corrosion resistant fastener

(71) Applicant: Ronald Murl Sundelin, Yorktown, VA (US)

(72) Inventor: Ronald Murl Sundelin, Yorktown, VA (US)

(21) Appl. No.: 16/350,091

(22) Filed: Sep. 24, 2018

(51) Int. Cl. H01B 17/56; B63C 5/02

(52) U.S. Cl. CPC H01B 17/56; B63C 5/02

(57) ABSTRACT

An object of this invention is to prevent the collapse of structures such as boat lifts, where the collapse is caused by corrosion of metal fasteners inside conductive material such as moist wood in the presence of external voltage differences, and where the corrosion is prevented by blocking current from flowing through the fasteners.

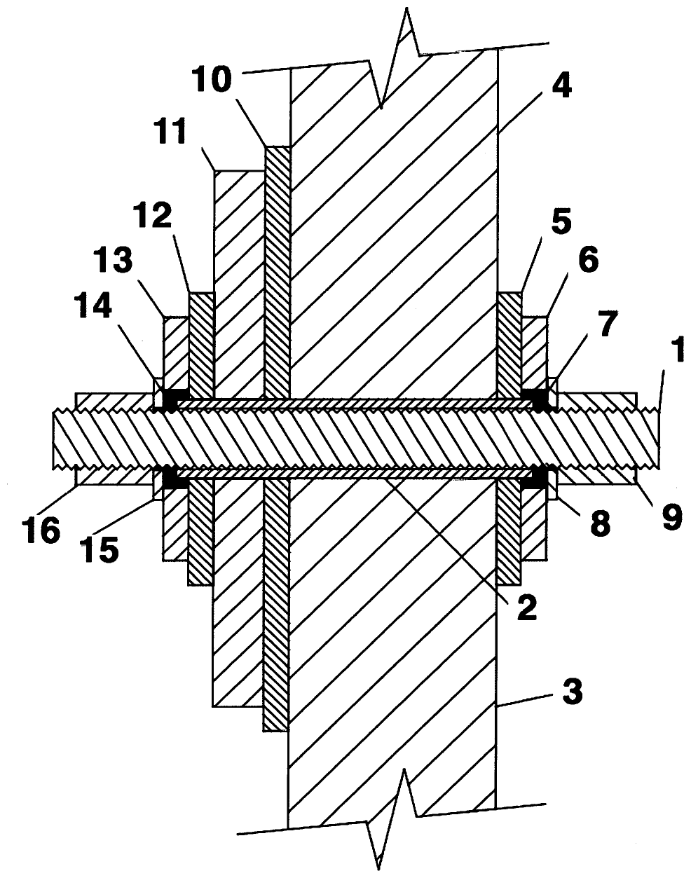

### CROSS-REFERENCE TO RELATED APPLICATIONS

Not applicable.

### FEDERALLY SPONSORED RESEARCH OR DEVELOPMENT

Not applicable.

### PARTIES TO A JOINT RESEARCH AGREEMENT

Not applicable.

### PRIOR DISCLOSURES BY INVENTOR

In or about 2011, as a public service the inventor disclosed information related to, but of a lesser scope than, this invention in the YouTube set of slides entitled “Boat Lift Danger”. Details are in the next section.

### BACKGROUND OF THE INVENTION

This invention addresses corrosion of fasteners connecting equipment such as boat lifts to structures such as pilings. A number of approaches have been used to mitigate this problem, but each has certain disadvantages. This corrosion is not readily observed because it takes place inside an opaque piling, and the visible portions exhibit little or no corrosion. The rate at which the corrosion takes place is generally not appreciated because two different ground voltages are normally involved, and the voltage difference can greatly accelerate the corrosion rate.

For side-mounted boat lift brackets, there are typically two bolts holding each bracket to a piling. The piling, typically pressure treated wood, tends to wick water and exhibit moderate electrical conductivity, and typically is in contact with earth ground potential. A boat lift is normally made of metal, is operated using 120 or 240 volts, and is connected to a personnel safety ground.

Depending on the relative polarity of the grounds, a non-negligible current can flow from the earth ground, preferentially through the lower bolt, through the support bracket, through the boat lift, and to the safety ground. Given sufficient time, this current has been observed to remove the central 85% of the lower bolt, and up to 80% of the cross section of the upper bolt at some locations. The associated voltage was 1 volt, and the current 0.003 amperes. The time to cause the described damage was 0.02 ampere-years.

The YouTube slides “Boat Lift Danger” explain the accelerated corrosion and its reason, and recommend installing electrical installation between the boat lift longitudinal beams and their support brackets. While this is a desirable thing to do, it is inadequate because various other items connected to the personnel safety ground are also connected to various parts of the wooden structure. Such items include flexible metal conduit with an easily penetrated insulating coating, the boat lift control box, and the electrical breaker panel. The result of this was that current from the ocean ground traveled up a piling, transferred to a lower bolt holding a boat lift support bracket, travelled through the bracket, transferred through the upper bolt back into the piling, and continued up the piling to a place that the safety-grounded conduit was in contact with the piling. This caused both bolts to corrode through and for the boat lift to collapse seven years after installation. This collapse caused major property damage and caused a risk of personnel injury or death. The present invention is intended to prevent such an event from occurring.

Other approaches that have been taken to mitigate corrosion in marine environments include use of sacrificial anode material (U.S. Pat. No. 3,887,449 A, Robert B Baer, Jun. 3, 1975; JP-4146994, Untranslated, Sep. 10, 2008), modulated current between anode and cathode (U.S. Pat. No. 5,627,414 A, Fordyce M. Brown et al., May 6, 1997; US-2009138148-A1, Sridhar Deivasigamani, abandoned), and triggerable solid state devices to bring the two ground voltages closer to each other (U.S. Pat. No. 5,840,164 A, Richard E. Staerzl, Nov. 24, 1998). The first of these approaches has the disadvantage that the sacrificial material needs to be monitored an periodically replaced; the second and third have the disadvantage of requiring a power source, special controls, and the disadvantage that the personnel safety ground could be rendered ineffective. Another approach is to use two bolts, one of which is designed to fail long before the second one fails (U.S. Pat. No. 9,823,690, Bowers , et al., Nov. 21, 2017). This approach has the disadvantage that the bolts must be monitored and periodically replaced. In addition to the patent search indicated above, discussions with boat lift manufacturers and an experienced boat lift installer indicate that the prior art provides no satisfactory solution to the problem addressed by this invention.

The inventor believes the present invention has the most overlap with USPC groups 52.515, 52.517, 174.23R, 204.96.16, and 204.196.37, and with CPC groups A47L, B23F, B27K, B41N, C04B, C09D, C09J, C23C, C23F, F16L, G01N, H01B, H01Q, H01R, and H02G.

### BRIEF SUMMARY OF THE INVENTION

This invention avoids corrosion and breakage of fasteners used to fasten apparatus to moderately conductive material such as pressure treated wood by electrically and chemically isolating the fastener from the material in which it is embedded. The isolating material is selected to have the properties of being a good electrical insulator, resistant to the chemicals present, not subject to fracture from mechanical shock, and not subject to excessive cold flow under moderately high pressures. The invention is for use in locations where two different ground voltages are present. One it typically an earth ground and the other a personnel safety ground. The load being supported is preferably isolated from the fastener to simplify verification that the fastener is isolated.

### BRIEF DESCRIPTION OF THE DRAWING

The invention is most easily understood with a sectional view, looking horizontally, in which the axis of a metallic fastener lies in the plane of the section, as illustrated in the drawing. The drawing shows a fastener embedded in a moderately electrically conductive material such as a moist pressure treated wooden piling, material which isolates the fastener from the conductive material, a supported load, and auxiliary components which operate cooperatively to accomplish the objectives of the invention.

### DETAILED DESCRIPTION OF THE INVENTION

A common problem, especially in marine structures, is the corrosion and subsequent breakage of metallic fasteners inside electrically conductive material such as pressure treated wood in which moisture is present. This problem is made much worse if the conductive material has an electrical connection to two different grounds at potentially different voltages. One ground commonly encountered is the earth ground contacted by a piling. A second ground commonly encountered is a personnel safety ground which is connected to electric-motor-driven or other equipment which is in contact with the same electrically conductive material. In such a configuration, a ground voltage difference of 1 volt has been encountered, and a current of 3 milliamperes has been measured. The current and time required to cause fastener failure is approximately 20 milliampere-years. Corrosion of the fasteners is not visible because it occurs inside the pilings. The rate of corrosion is increased at the location of stresses in the fastener. This information was made public several years ago by the present inventor in the YouTube slides entitled “Boat Lift Danger”. It is recommended in that presentation that components connected to each of the two grounds be electrically insulated from each other. It was specified that longitudinal beams in a boat lift, with attached motors connected to power line ground, be electrically insulated from the support brackets connected to pilings. In a subsequent case, other ground sources farther from the brackets, such as control boxes, plastic-covered flexible metallic conduit, and breaker panels were not taken into account. These additional grounds have led to a boat lift collapse seven years after the bolts were installed. A completed 2 month test on the present invention, with a 5,000 pound shear load applied to the supported bracket, extrapolates to a corrosion lifetime inside the piling in excess of 30,000 years. Exposure to weather outside the piling would be expected to yield a shorter lifetime, but one well in excess of the lifetime of the wood.

Other reasons a second ground may be in contact with earth-grounded conductive material include illumination, availability of general purpose electrical power, and provision of electrical power to a boat. One way the galvanic corrosion can be accelerated is the connection of a safety ground to a structure which is electrically connected to a fastener embedded in the earth-grounded conductive material. A second way the corrosion can be accelerated is the connection of a second ground to the conductive material at a point, on the opposite side from earth ground, from two metallic fasteners embedded in the material if the fasteners are electrically connected to each other by a metallic path; in this case, current flowing through the conductive material will exit through one fastener, travel through the metallic path, and reenter through the second fastener, thereby corroding both fasteners.

This invention avoids problems with multiple grounds by electrically insulating the fasteners inside the conductive medium. The components attached to the ends of the fasteners are also electrically insulated from the pilings. It is also desirable, but not essential, to electrically isolate the components supported by the fasteners. The advantage of this approach is that the proper functioning of the insulation on a fastener can be verified by measuring its resistance to other objects.

The invention can be most easily understood by looking at the drawing, which shows a horizontally viewed section in which the axis of the fastener lies in the plane of the section. The drawing shows a section through a metallic fastener, a piece of lumber in which it is embedded, and a structural member which it is supporting. A threaded rod (1) is insulated by a non-conductive tube (2), which passes through a hole in the conductive material (3). The lower end of the conductive material (3) will have a route to a ground voltage, and the upper end (4) can have a route to a ground at a different voltage. One end of the tube (2) passes through an insulator (5) and into a metal spacer (6). A sealant (7) is placed between the tube (2) and spacer (6), which extends past the end of the tube (2). A metal washer (8) of the correct size for the threaded rod (1) and a nut (9), with nylon locking means, prevent the threaded rod (1) from being pulled out of the other side of the hole. On the opposite side of the conductive material, an insulator (10) is placed over the tube (2) and sealed to it. This insulator prevents the supported structural member (11), which can have a route to a ground at a different voltage than earth ground, from making electrical or chemical contact with the conductive material (3). An additional insulator (12) electrically insulates the supported member (11) from making electrical contact with the threaded rod (1). A metal spacer (13) extends past the end of the tube (2), and sealant (14) is placed in the space between them. Washer (15) provides a bearing surface for nut (16); this nut is tightened and is of the nylon locking type.

The conductive material, such as pressure treated wood, is made more conductive by moisture. The moisture level and conductivity are increased if the wood is embedded in moist earth or is in contact with water, especially salt water. The materials in the wood, such as preservatives, contribute to the conductivity to the extent to which they are ionized. Conductive materials, as described herein, have lower resistivity than electrically insulating materials and higher resistivity than metals such as copper.

The insulating material should not be brittle, should be resistant to the chemicals to which it is exposed, and should be resistant to cold flow under heavy load. Polyurethane with hardness around 80 A is preferred for this purpose.

Whereas galvanic corrosion can be inhibited if the metallic object is held at a voltage of appropriate polarity, it is not practical to shift the voltage associated with earth ground, and modifying the personnel safety ground voltage would have the risk of interfering with the personnel safety and overcurrent grounding function.

As used herein, “metal” and “metallic” refer to materials with resistivity of 2 microohm-meters or less, “insulated” refers to materials with 10 megohm-meters or greater, and “conductive material” generally refers to material with resistivity between 0.002 ohm-meters and 200 ohm-meters, but may apply to a broader range in the presence of different geometries.

Conductive material useful for structural purposes includes wood, pressure treated wood, lumber, pilings, and any other material having appropriate strength, rigidity, durability, and resistivity. “Inside the conductive medium” also includes the case of corrosion taking place, in a place where it cannot be visually observed, and in which corrosion can lead to unacceptable weakening of the structure.

“Fastener” refers to any device used to control the relative motion of any number of objects which would not maintain desired positions in the absence of the fastener. The term includes, but is not limited to, bolts, screws, threaded rods, lag bolts, and lag screws, plus auxiliary components such as nuts, flat washers, and lock washers. Appropriate fastener materials include galvanized steel and stainless steel. If the latter is used, an anti-seize compound may be required to prevent galling.

The spacers shown in the drawing serve the purposes of transmitting axial forces, distributing forces over a relatively large area, accommodating variations in the length of the insulating tube, and providing space for a sealant which prevents the entry of liquids into the space between the fastener and insulating tube.

The insulating materials which are installed perpendicular to the insulating tube axis should have their holes formed in such a way that the joints between the two insulators are liquid tight. Alternatively, sealant can be applied to the joint.

“Ground” as used herein can include other sources of voltages, including but not limited to, line “neutral”.

What is claimed is:

1. A structure comprising a metallic fastener, which fastener is electrically insulated from a conductive material in which it is at least partially embedded, a member supported by the fastener, and a plurality of external voltages which would otherwise cause an electrical current to flow between the conductive material and the metallic fastener if the two were not separated by an insulator.

2. A structure according to claim 1 in which the conductive material is pressure treated wood.

3. A structure according to claim 1 in which one voltage is that of the earth's ground.

4. A structure according to claim 1 in which one voltage is that of a personnel safety ground.

5. A structure according to claim 1 in which a first voltage is that of the earth's ground and a second voltage is that of a personnel safety ground.

6. A boat lift comprising an electric motor drive, a personnel safety ground connected to a metallic member of the boat lift, supporting means including at least one metallic fastener, such fastener providing attachment means to a conductive material which has an electrically conductive path to earth ground, and an insulator which prevents current from flowing between the conductive material and the metallic fastener.

7. A boat lift according to claim 6 in which the supporting means are electrically insulated from the metallic fastener.

8. A boat lift according to claim 6 in which the boat lift is protected from chemicals in the conductive material.
